(19) United States
(12) Patent Application Publication
(10) Pub. No.: US 2005/0055295 A1
(43) Pub. Date: Mar. 10, 2005

(54) Method and system for providing stable value

(76) Inventors: Douglas F. Bateson, New York, NY (US); Michael H. Monforth, Ridgewood, NJ (US); Patrick J. Hellen, South Orange, NJ (US); Scott A. Kay, Brooklyn, NY (US)

Correspondence Address: MILBANK, TWEED, HADLEY & MCCLOY LLP, 1 CHASE MANHATTAN PLAZA, NEW YORK, NY, 10005-1413, US

(21) Appl. No.: 10/656,408

(22) Filed: Sep. 5, 2003

(51) Int. Cl. G06F 17/60

(52) U.S. Cl. 705/35

(57) ABSTRACT

Separate accounts of life insurance carriers receive premiums for company owned life insurance (COLI). The premiums are invested in a stable value fund along with net premiums from other separate accounts. The stable value fund enters into a derivative contract with a stable value provider. The stable value fund calculates and reports book value of the investments to the separate accounts, which report the book value to the policy holders. The separate account investors share in the potential risk and reward from early withdrawals by other fund investors.

### BACKGROUND

1. Field of the Invention

The invention relates to the field of financial instruments, risk management and stabilizing investment returns, and more particularly to stable value contracts.

2. Description of the Related Art

Stable value products for individual entities are known in certain financial areas.

What is needed is a system and method for providing stable value products to a broader spectrum of entities, while reducing the risk of early withdrawal.

The preceding description is not to be construed as an admission that any of the description is prior art relative to the present invention.

### SUMMARY OF THE INVENTION

In one embodiment, the invention provides a system and method for providing stable value. The method and system comprise agreeing to provide a first stable return to a first entity, the first stable return correlated to a first plurality of life insurance policies, agreeing to provide a second stable return to a second entity, the second stable return correlated to a second plurality of life insurance policies, and combining aspects of the first and second agreements. The combined aspects of the first and second agreement distributes some risk of early withdrawal by the first entity to the second entity.

In another embodiment, the invention provides a system and method for providing stable value where combining aspects of the first and second agreements further comprises investing in a stable value fund and entering into a stable value derivative contract.

In another embodiment, the invention provides a system and method for providing stable value further comprising using the stable returns to fund employee benefit plans and/or hedge employee benefit plans.

In another embodiment, the invention provides a system and method for providing stable value further comprising periodically adjusting values of the first and second stable returns.

In another embodiment, the invention provides a system and method for providing stable value where the first and second entities are separate accounts of a life insurance company.

In another embodiment, the invention provides a system and method for providing stable value where the first and second plurality of life insurance policies are company owned life insurance policies.

In another embodiment, the invention provides a system and method for providing stable value where the company is a corporation, a bank or a trust.

In another embodiment, the invention provides a system and method for providing stable value where the first and second agreements are between a provider of stable value and first and second insurance companies respectively.

In another embodiment, the invention provides a system and method for providing stable value where the first and second stable returns are provided to respective first and second companies.

In another embodiment, the invention provides a system and method for providing stable value. The method and system comprises creating a fund to provide a plurality of stable returns to a plurality of entities, the stable returns correlated to a plurality of life insurance policies, and receiving investments in the fund, where participation in the fund distributes some risk of early withdrawal by any one of the entities to the remaining entities.

In another embodiment, the invention provides a system and method for providing stable value further comprising entering into a stable value derivative contract.

In another embodiment, the invention provides a system and method for providing stable value further comprising calculating a book value per unit for each of the investments in the fund and calculating a market value per unit for each of the investments in the fund.

In another embodiment, the invention provides a system and method for providing stable value further comprising using the book value per unit for qualified withdrawals from the fund.

In another embodiment, the invention provides a system and method for providing stable value further comprising sharing among remaining investors a cost of a pro rata share of an excess of book value per unit over market value per unit when the book value per unit exceeds the market value per unit.

In another embodiment, the invention provides a system and method for providing stable value further comprising receiving a payment in an amount sufficient to increase the market value per unit to equal the book value per unit when the book value per unit exceeds the market value per unit and the market value is less than an amount of the qualified withdrawal.

In another embodiment, the invention provides a system and method for providing stable value further comprising sharing among remaining investors a benefit of a pro rata share of the excess of market value per unit over book value per unit when the market value per unit exceeds the book value per unit.

In another embodiment, the invention provides a system and method for providing stable value further comprising using the lesser of the book value per unit or the market value per unit for non-qualified withdrawals from the fund.

In another embodiment, the invention provides a system and method for providing stable value further comprising sharing among remaining investors a benefit of a pro rata share of the excess of market value per unit over book value per unit or an exit fee from the non-qualified withdrawal.

In another embodiment, the invention provides a system and method for providing stable value further comprising determining interest of a new investment in the fund using a book value of the fund.

In another embodiment, the invention provides a system and method for providing stable value further comprising liquidating the fund and making distributions at book value per unit.

In another embodiment, the invention provides a system and method for providing stable value further comprising liquidating the fund and receiving a payment in an amount sufficient to increase the market value per unit to equal the book value per unit, if the book value per unit is greater than the market value per unit.

In another embodiment, the invention provides a system and method for providing stable value further comprising liquidating the fund and making a payment in an amount corresponding to an excess of the market value per unit over the book value per unit, if the market value per unit is greater than the book value per unit.

In another embodiment, the invention provides a system and method for providing stable value. The method and system comprises establishing a separate account, receiving a premium for a company owned life insurance policy, investing a substantial portion of the premium in a fund, the fund receiving similar investments by similar entities, and participating in the risk or reward of fund early withdrawal by any of the similar entities.

In another embodiment, the invention provides a system and method for providing stable value further comprising receiving information corresponding to a book value of the investment and reporting the book value information to policy holders for use in periodic financial statements.

In another embodiment, the invention provides a system and method for providing stable value further comprising sharing a cost of a pro rata share of an excess of a book value per unit over a market value per unit when the book value per unit exceeds the market value per unit.

In another embodiment, the invention provides a system and method for providing stable value further comprising receiving a payment in an amount sufficient to increase a market value per unit to equal a book value per unit when the book value per unit exceeds the market value per unit and the market value is less than an amount of a qualified withdrawal.

In another embodiment, the invention provides a system and method for providing stable value further comprising sharing a benefit of a pro rata share of an excess of a market value per unit over a book value per unit when the market value per unit exceeds the book value per unit.

In another embodiment, the invention provides a system and method for providing stable value further comprising sharing a benefit of a pro rata share of an excess of a market value per unit over a book value per unit or an exit fee from a non-qualified withdrawal.

The foregoing specific objects and advantages of the invention are illustrative of those which can be achieved by the present invention and are not intended to be exhaustive or limiting of the possible advantages that can be realized. Thus, the objects and advantages of this invention will be apparent from the description herein or can be learned from practicing the invention, both as embodied herein or as modified in view of any variations which may be apparent to those skilled in the art. Accordingly the present invention resides in the novel parts, constructions, arrangements, combinations and improvements herein shown and described.

### BRIEF DESCRIPTION OF THE DRAWINGS

The foregoing features and other aspects of the invention are explained in the following description taken in conjunction with the accompanying figures wherein:

FIG. 1 illustrates an embodiment of company owned life insurance;

FIG. 2 illustrates an embodiment of stable value provided with company owned life insurance; and

FIG. 3 illustrates an embodiment of a stable value find managed by an asset manager and multiple insurance carriers, each with separate accounts.

It is understood that the drawings are for illustration only and are not limiting.

### DETAILED DESCRIPTION OF THE DRAWINGS

In one embodiment, the invention provides an investment strategy that can be offered to clients who seek to hedge employee benefit liabilities and stabilize returns on the investment.

To accomplish these objectives, the invention uses a combination of Corporate Owned Life Insurance (COLI) policies, which companies often use to hedge and/or fund their benefit liabilities; and a Stable Value Fund that offers a stable return.

Corporate Owned Life Insurance (COLI)

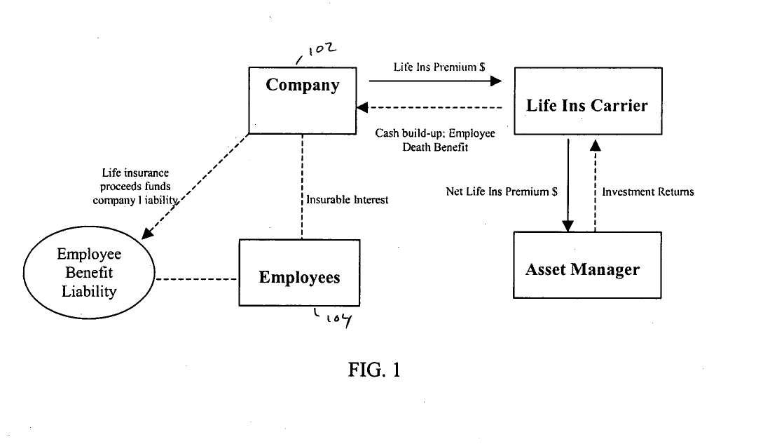

As illustrated in FIG. 1, COLI policies are life insurance contracts purchased by companies 107, such as trusts, banks and corporations on a pool of their employees 104. Since the corporation is the beneficiary of the employee death benefit as well as the cash surrender value, corporations use COLI to hedge and/or fund their employee benefit plans. COLI policies are attractive vehicles to hedge and/or fund such liabilities because the policy's cash build-up is tax free if the policy is held until death of the insured (the premium, however, is not tax deductible). These policies bear no cost to employees being covered. Rather, the employees benefit indirectly from the policies by virtue of the fact that the policies provide companies an efficient means of hedging and/or funding their benefit plans.

COLI policies are long-term contracts, which employers typically hold until death of the insured employee since early surrender will cause the cash build-up within the policy to become taxable, and in cases where the policy is a modified endowment contract, a 10% additional tax is levied.

Stable Value

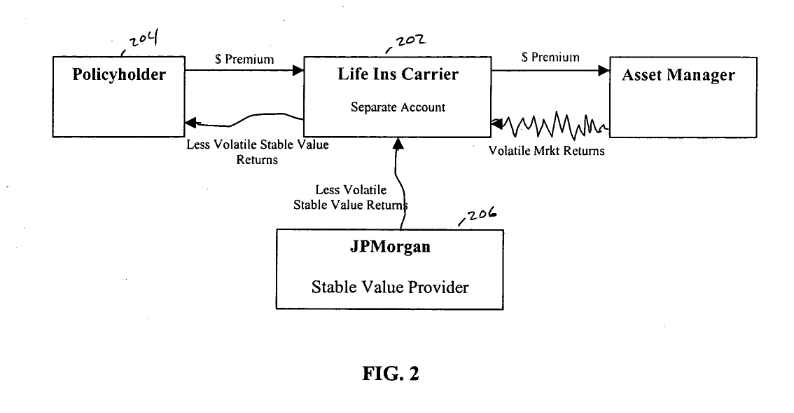

For reasons that are explained below, there are advantages to associating a stable value contract with the COLI, as illustrated in FIG. 2.

Generally accepted accounting principles call for an owner of such a company owned life insurance policy to report the cash surrender value of the policy on its balance sheet. The change in cash surrender value of the COLI policy is booked through the income statement. Depending on how the assets within the policy are invested, COLI returns can be volatile. Such volatility is generally deemed unattractive, especially in cases where the asset returns do not offset/hedge corresponding volatile liabilities.

Two general forms of COLI are in evidence. In the first, death benefit payments are made entirely from the insurance company's general account and in the second, death benefit payments are made in part from a separate account established to fund the policies of specific policyholders and in part from the general account. The principal reason for establishing a separate account is to ensure that premium payments and accumulated earnings are protected from the creditors of the insurance company.

In the case of policies supported by a carrier's general account, the cash surrender value grows at a relatively stable crediting rate that typically changes only once each year. However, when COLI is supported by a separate account, the change in cash surrender value for any reporting period is effectively the change in market value of the securities owned by the separate account. Because the policyholder reports such changes in cash surrender value in its income statement, the policyholder is effectively exposed to fluctuations in market value of securities in the separate account.

In order to mitigate the mark-to-market volatility associated with separate account life insurance policies, insurance companies 202 may enter into derivative contracts known as “stable value contracts” with stable value providers 206. These derivative contracts allow fluctuations in separate account value to be greatly reduced and, as a result, the policyholder 204 is able to report much more stable cash surrender values over time. A stable value rider or contract thus allows the policyholder to record less volatile COLI returns through its income statement and record the “book value” as the cash surrender value. The contract dampens volatility by deferring and amortizing market value gains and losses into the cash surrender value of the policy. Specifically, as the market value of the assets change, those changes are accreted into the cash surrender value of the policy by application of a calculated crediting rate that is reset periodically.

Typically, insurers 202 enter into stable value contracts with third party providers 206 to enable the insurer to provide stable value riders to their policyholders. JPMorgan is a third party provider of stable value contracts to insurance companies.

Stable Value Fund

Stable value derivative contracts tend to be complex and highly structured and, because of this, are typically utilized by insurance companies only if the policy involves a substantial premium. As a result, smaller policyholders are not able to benefit from the stable investment performance offered by a separate account that has entered into a stable value derivative contract.

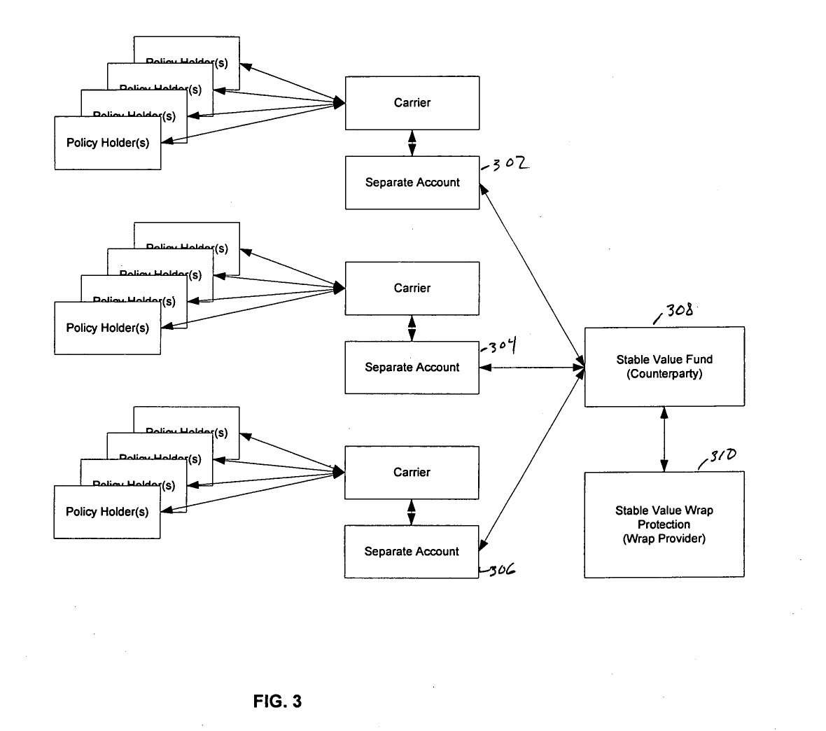

In a variation on stable value provided for a single client, the separate accounts 302, 304, 306 may purchase interests in a stable value fund 308, managed by an asset manager, rather than directly entering into a stable value derivative contract. This is illustrated in FIG. 3.

The stable value fund, in turn, enters into a stable value derivative contract with a third-party stable-value-derivative provider (a “wrap provider”) 310. In this manner, an insurance company separate account 302, 304, 306 can achieve stable value investment results by investing in a stable value fund 308 (rather than the normal approach of entering into a separate stable value derivative contract to offset volatility of market value investment performance).

As one embodiment, initial pro rata ownership of interests in the stable value fund is based on the amount invested by a given investor as a percentage of book value of the fund (rather than the normal approach of determining pro rata ownership of a fund based on the amount invested as a percentage of the market value of the fund).

As one embodiment, book value and market value per unit are tracked and reported separately, with book value per unit being the amount payable to an investor for a qualified withdrawal from the fund and the lesser of book value or market value per unit (subject to a minimum exit fee) being the amount payable to an investor in the case of a non-qualified withdrawal.

As one embodiment, in the event of a qualified withdrawal resulting from a policy surrender at a time when the book value of the stable value fund exceeds the market value of the assets owned by the stable value fund, each of the remaining investors in the stable value fund will, over time (by operation of the crediting rate formula), bear the cost of a pro rata share of the excess of book value over market value attributable to that withdrawal.

As one embodiment, in the event of a qualified withdrawal resulting from a policy surrender at a time when the book value of the stable value fund exceeds the market value of the assets owned by the stable value fund and the market value of the stable value fund is less than the amount of the qualified withdrawal, the stable-value-derivative provider will make a payment to the stable value fund in an amount sufficient to increase market value of the fund to equal book value of the fund.

As one embodiment, in the event of a qualified withdrawal resulting from a policy surrender at a time when the market value of the stable value fund exceeds the book value of the assets owned by the stable value fund, each of the remaining investors in the stable value fund will, over time (by operation of the crediting rate formula), benefit from a pro rata share of the excess of market value over book value attributable to that withdrawal.

As one embodiment, in the event of a non-qualified withdrawal, each of the remaining investors in the stable value fund will, over time (by operation of the crediting rate formula), benefit from a pro rata share of the greater of any positive excess of market value over book value or the exit fee attributable to that withdrawal.

As one embodiment, once the stable value fund falls below a certain minimum size, it is gradually liquidated, over a period of years, such as 7.5 years, with liquidation distributions being made at book value per unit.

As one embodiment, if at the end of the gradual liquidation process, book value of the stable value fund is greater than market value of the stable value fund, the stable-value-derivative provider will make a payment to the stable value fund in an amount sufficient to increase market value of the fund to equal book value of the fund.

As one embodiment, if at the end of the gradual liquidation process, market value of the stable value fund is greater than book value of the stable value find, the stable-value-derivative provider will receive a payment from the stable value fund in an amount equal to the excess of market value over book value of the fund.

The aspects of the embodiments where the investors bear the cost or receive a benefit as a result of a qualified or non-qualified withdrawal can be considered to be participation in the fund by the investors.

### EXAMPLE EMBODIMENTS

The invention has particular application to “small-case,” corporate-owned, bank-owned and trust-owned life insurance policies (each, a “Policy”) that are modified endowment contracts (“MEC”).

A Counterparty 308 offers an asset management fund with imbedded stable value protection (the “Stable Value Fund”) to separate accounts (each, a “Separate Account”) 302, 304, 306 of at least one life insurance company (each, a “Carrier”). In the example embodiment, the Carriers do not enter into stable value wrap agreements directly with the Wrap Provider 310 with respect to investments in the Stable Value Fund.

The interests in the Stable Value Fund that are held by a Separate Account of a Carrier with respect to a given Policy can be referred to as a “Wrapped Portfolio.”

For a given Separate Account, the number of Units acquired at the time of an investment in the Stable Value Fund is determined by dividing the amount of the investment by the Aggregate Book Value of the Stable Value Fund (excluding such investment) and dividing the result by the number of Units outstanding prior to the new investment.

On any date, the Aggregate Book Value of the Stable Value Fund can be calculated as follows: the sum of Initial Book Value for all Wrapped Portfolios; plus Accrued Interest earned to date; plus Portfolio Additions made to date; minus Redemptions made to date; minus Book Value Surrender payments; minus Liquidity Surrender payments; minus Withdrawals; minus Impaired Security Adjustments; minus Non-Conforming Security Adjustments; minus Program Unwind Amounts.

On any date, the Aggregate Market Value of the Stable Value Fund can be calculated as the fair market value of all securities held by the Stable Value Fund.

On any date, the Book Value per Unit can be calculated as the Aggregate Book Value, divided by the number of Units outstanding. Similarly, the Market Value per Unit can be calculated as the Aggregate Market Value, divided by the number of Units outstanding.

On any date, the Book Value amount of a given Wrapped Portfolio can be calculated as follows: Book Value per Unit; multiplied by the number of Units of the Stable Value Fund that are owned by the relevant Separate Account. Also, on any date, the Market Value of a given Wrapped Portfolio can be calculated as follows: Market Value per unit, multiplied by the number of Units of the Stable Value Fund that are owned by the relevant Separate Account.

The Stable Value Fund is credited with Accrued Interest at the Crediting Rate. The Crediting Rate is periodically reset, such as quarterly on March 31, June 30, September 30, and December 31 and on other Reset Dates.

The Crediting Rate applicable to any Reset Period is calculated by the Wrap Provider as follows:

$$CR = {( \frac{MV}{BV} )}^{1 / D} * ( 1 + Y ) - 1$$

where
“CR” is the Crediting Rate, expressed as a percentage. CR is not lower than zero percent;
“MV” is the Aggregate Market Value of the Stable Value Fund as of the applicable Reference Date;
“BV” is the Aggregate Book Value of the Stable Value Fund as of the applicable Reference Date;
“D” is the Duration as of the applicable Reference Date; and
“Y” is the Yield as of the applicable Reference Date.

Accrued Interest is calculated by the Wrap Provider as follows:
AI=BV*((1+CR)^{1/DC}−1)
where
“AI” is the amount of Accrued Interest earned for any given day;
“BV” is the Aggregate Book Value on the immediately preceding day;
“CR” is the Crediting Rate applicable to such day; and
“DC” is equal to 365 (or, if such day falls during a leap year, 366).

A Carrier may redeem Units in the Stable Value Fund to cover any Redemption.

In the case of any Death Benefits Redemption or any Redemption to cover Cost of Insurance, Aggregate Book Value is reduced by an amount equivalent to the Redemption divided by the ratio of Market Value to Book Value that existed immediately prior to the Redemption. In the case of any other Redemption, Aggregate Book Value is reduced by an amount equivalent to the Redemption.

If (i) a Policyholder elects to surrender a Policy, (ii) the relevant Carrier accepts the surrender notice and the Policy is deemed surrendered, (iii) within five days of the Surrender Notice Date, the Policyholder makes the Book Value Surrender Representations, and (iv) the Book Value Surrender Representations are true, correct and complete on each day of the period between the Surrender Notice Date and the Book Value Surrender Payment Date, the Counterparty shall, on the Book Value Surrender Payment Date, distribute to the relevant Carrier an amount in cash equivalent to Book Value as of the Book Value Surrender Notice Date and the Units formerly held by the applicable Carrier shall be deemed to have been redeemed.

If the Policyholder does not timely make the Book Value Surrender Representations, or if the Counterparty determines at any time during the period between the Surrender Notice Date and the Book Value Surrender Payment Date that any of the Book Value Surrender Representations made by Policyholder are not true, correct and complete, the Counterparty shall so advise the Carrier and a Book Value Surrender shall not be available to the Carrier. Instead, a Liquidity Surrender shall be initiated.

If a Policyholder surrenders a Policy in the context of a Section 1035 Exchange and the replacement Carrier maintains the prior level of investment in the Stable Value Fund, no payment would be made from the Stable Value Fund. Instead, the books and records of the Stable Value Fund would reflect ownership of the assets being transferred from the former Carrier to the new Carrier.

If a Policyholder surrenders a Policy but does not qualify for a Book Value Surrender or a Permitted 1035 Exchange, the final distribution from the Stable Value Fund, calculated as follows, would be made by the Counterparty to the relevant Carrier on the Liquidity Surrender Payment Date in full redemption of the Units held by the applicable Carrier:

If Book Value exceeds Market Value on the Surrender Notice Date, the amount distributed would be equivalent to Market Value on the Surrender Notice Date, less the Surrender Fee;

If Market Value exceeds Book Value by an amount equal to or less than the Surrender Fee, the amount distributed would be equivalent to Market Value on the Surrender Notice Date, less the Surrender Fee;

If Market Value exceeds Book Value by more than the amount of the Surrender Fee, the amount distributed would be equivalent to Book Value on the Surrender Notice Date.

Any excess of Market Value over Book Value not distributed to the Carrier would be retained in the Stable Value Fund for the benefit of remaining participants.

If a Policyholder elects not to continue with its investment in the Stable Value Fund (but does not surrender its Policy), a distribution calculated as follows will be made out of the Stable Value Fund to the Carrier or transferred to non-stable value investment funds managed by the Counterparty:

If Book Value exceeds Market Value on the day prior to distribution, the amount distributed would be equivalent to Market Value on the Surrender Notice Date, less the Surrender Fee;

If Market Value exceeds Book Value on the day prior to distribution by an amount equal to or less than the Surrender Fee, the amount distributed would be equivalent to Market Value on the Surrender Notice Date, less the Surrender Fee; and

If Market Value exceeds Book Value on the day prior to distribution by more than the amount of the Surrender Fee, the amount distributed would be equivalent to Book Value on the Surrender Notice Date.

Any remaining excess of Market Value over Book Value shall be retained in the Stable Value Fund for the benefit of remaining participants.

Unless a Program Unwind and subsequent Program Cash Settlement occurs, the cash necessary to fund any payment due to a Carrier in connection with a Policy shall be generated solely through the liquidation of securities held within the Stable Value Fund.

The operation of this provision has the following implications at the time of a Book Value payment in connection with a given Policy when Book Value differs from Market Value:

Securities equal in value to the amount needed to fund the Book Value payment obligation will be liquidated;

Aggregate Market Value and Aggregate Book Value will decrease by the amount of the securities liquidated;

The Crediting Rate applicable to the Stable Value Fund will change as a result of the change in Market Value/Book Value relationships; and

The difference between Market Value and Book Value paid out will be amortized through the adjusted Crediting Rate applicable to the remaining Stable Value Fund investors. Other factors may influence the amortization.

The Stable Value Program would terminate upon the completion of a Program Unwind. A Program Unwind would be initiated if any of the following occurs:

Aggregate Book Value falls below a specific value, such as $100,000,000; or

The number of Policies benefiting from the Stable Value Fund falls below a specific number, such as 10.

If a Program Unwind is initiated, all investments of the Stable Value Fund will be liquidated and then reinvested in accordance with Immunized Guidelines. Assets managed in accordance with Immunized Guidelines will gradually be liquidated over a 30-quarter period, with liquidation proceeds transferred to other investment funds offered by Counterparty. On any Quarterly Anniversary Date that occurs subsequent to the initiation of a Program Unwind, the amount to be liquidated and reinvested (the “Program Unwind Amount”) shall be:

The Aggregate Book Value on the day prior to the relevant Quarterly Anniversary Date; divided by the number of remaining Quarterly Anniversary Dates including the current Quarterly Anniversary Date.

A Program Cash Settlement will take place on the Program Cash Settlement Date, which would occur at the completion of the 30-quarter period or on the earliest date during the Program Unwind that either of the following statements is true (after giving effect to any payment then due from the Stable Value Fund):

Aggregate Book Value is not greater than zero; or

Aggregate Market Value is not greater than zero.

The Program Cash Settlement obligations of the Wrap Provider and the Counterparty would be as follows:

If, on the day prior to the Program Cash Settlement Date, Aggregate Book Value is greater than Aggregate Market Value, the Wrap Provider would pay to the Counterparty the excess of Aggregate Book Value over Aggregate Market Value;

If, on the day prior to the Program Cash Settlement Date, Aggregate Market Value is greater than Aggregate Book Value, the Counterparty would pay to the Wrap Provider the excess of Aggregate Market Value over Aggregate Book Value.

Although illustrative embodiments have been described herein in detail, it should be noted and will be appreciated by those skilled in the art that numerous variations may be made within the scope of this invention without departing from the principle of this invention and without sacrificing its chief advantages.

In particular, in other embodiments, the separate accounts of the life insurance carriers may include only the policy holders of a single company, or may include policy holders from multiple companies. Similarly, a single insurance carrier may have multiple separate accounts.

In other embodiments, the adjustments based on a reset of the crediting rate need not occur at only quarterly periods, but may occur weekly, daily, annually or even non-periodically.

In other embodiments, the pro-rata participation by investors need not include both payment of costs and receipt of benefit, but may include only payment of costs, or only receipt of benefit.

In other embodiments, the manager of the stable value fund and the wrap provider may be the same entity.

Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

1. A method for providing stable value, the method comprising:
agreeing to provide a first stable return to a first entity, the first stable return correlated to a first plurality of life insurance policies;
agreeing to provide a second stable return to a second entity, the second stable return correlated to a second plurality of life insurance policies; and
combining aspects of the first and second agreements, wherein the combined aspects of the first agreement and the second agreement distributes some risk of early withdrawal by the first entity to the second entity.

2. A method according to claim 1, wherein combining aspects of the first and second agreements further comprises:
investing in a stable value fund; and
entering into a stable value derivative contract.

3. A method according to claim 1, further comprising:
using the stable returns to fund employee benefit plans.

4. A method according to claim 1, further comprising:
using the stable returns to hedge employee benefit plans.

5. A method according to claim 1, further comprising:
periodically adjusting values of the first and second stable returns.

6. A method according to claim 1, wherein the first and second entities are separate accounts of a life insurance company.

7. A method according to claim 1, wherein the first and second plurality of life insurance policies are company owned life insurance policies.

8. A method according to claim 7, wherein the company is a corporation.

9. A method according to claim 7, wherein the company is a bank.

10. A method according to claim 7, wherein the company is a trust.

11. A method according to claim 1, wherein the first and second agreements are between a provider of stable value and first and second insurance companies respectively.

12. A method according to claim 1, wherein the first and second stable returns are provided to respective first and second companies.

13. A method for providing stable value, the method comprising:
creating a fund to provide a plurality of stable returns to a plurality of entities, the stable returns correlated to a plurality of life insurance policies; and
receiving investments in the fund, wherein participation in the fund distributes some risk of early withdrawal by any one of the entities to the remaining entities.

14. A method according to claim 13, further comprising:
entering into a stable value derivative contract.

15. A method according to claim 13, further comprising:
calculating a book value per unit for each of the investments in the find; and
calculating a market value per unit for each of the investments in the fund.

16. A method according to claim 15, further comprising:
using the book value per unit for qualified withdrawals from the fund.

17. A method according to claim 16, further comprising:
sharing among remaining investors a cost of a pro rata share of an excess of book value per unit over market value per unit when the book value per unit exceeds the market value per unit.

18. A method according to claim 16, further comprising:
receiving a payment in an amount sufficient to increase the market value per unit to equal the book value per unit when the book value per unit exceeds the market value per unit and the market value is less than an amount of the qualified withdrawal.

19. A method according to claim 16, further comprising:
sharing among remaining investors a benefit of a pro rata share of the excess of market value per unit over book value per unit when the market value per unit exceeds the book value per unit.

20. A method according to claim 15, further comprising:
using the lesser of the book value per unit or the market value per unit for non-qualified withdrawals from the fund.

21. A method according to claim 20, further comprising:
sharing among remaining investors a benefit of a pro rata share of the excess of market value per unit over book value per unit or an exit fee from the non-qualified withdrawal.

22. A method according to claim 13, further comprising:
determining interest of a new investment in the fund using a book value of the fund.

23. A method according to claim 13, further comprising:
liquidating the fund; and
making distributions at book value per unit.

24. A method according to claim 13, further comprising:
liquidating the fund; and
receiving a payment in an amount sufficient to increase the market value per unit to equal the book value per unit, if the book value per unit is greater than the market value per unit.

25. A method according to claim 13, further comprising:
liquidating the fund; and
making a payment in an amount corresponding to an excess of the market value per unit over the book value per unit, if the market value per unit is greater than the book value per unit.

26. A method for providing stable value, the method comprising:
establishing a separate account;
receiving a premium for a company owned life insurance policy;
investing a substantial portion of the premium in a fund, the fund receiving similar investments by similar entities; and
participating in the risk or reward of fund early withdrawal by any of the similar entities.

27. A method according to claim 26, further comprising:
receiving information corresponding to a book value of the investment; and
reporting the book value information to policy holders for use in periodic financial statements.

28. A method according to claim 26, further comprising:
sharing a cost of a pro rata share of an excess of a book value per unit over a market value per unit when the book value per unit exceeds the market value per unit.

29. A method according to claim 26, further comprising:
receiving a payment in an amount sufficient to increase a market value per unit to equal a book value per unit when the book value per unit exceeds the market value per unit and the market value is less than an amount of a qualified withdrawal.

30. A method according to claim 26, further comprising:
sharing a benefit of a pro rata share of an excess of a market value per unit over a book value per unit when the market value per unit exceeds the book value per unit.

31. A method according to claim 26, further comprising:
sharing a benefit of a pro rata share of an excess of a market value per unit over a book value per unit or an exit fee from a non-qualified withdrawal.

32. A method for providing stable value to company owned life insurance policy holders, the method comprising:
creating a stable value fund to provide a plurality of stable returns to a plurality of life insurance company separate accounts, the stable returns correlated to a plurality of life insurance policies issued by the separate accounts;
receiving investments in the stable value fund from the separate accounts, wherein each separate account participates in the risk from early withdrawal by any of the other separate accounts, or the benefit from early withdrawal by any of the other separate accounts;
entering into a stable value derivative contract with a wrap provider;
calculating a book value per unit for each separate account using a crediting rate;
reporting the book value per unit to each separate account;
periodically resetting the crediting rate;
recalculating the book value per unit; and
reporting the recalculated book value per unit to each separate account.
